(19) United States
(12) Patent Application Publication
(10) Pub. No.: US 2003/0012252 A1
(43) Pub. Date: Jan. 16, 2003

(54) Fast response optical power meter

(76) Inventor: Eliyahu Bender, Jerusalem (IL)

Correspondence Address: Welsh & Katz, 22nd Floor, 120 South Riverside Plaza, Chicago, IL, 60606-3913, US

(21) Appl. No.: 10/110,791

(22) PCT Filed: Aug. 16, 2001
(86) PCT No.: PCT/IL01/00774

(30) Foreign Application Priority Data
Aug. 16, 2000 (IL) 137907

(51) Int. Cl. G01K 17/20; G01J 1/42

(52) U.S. Cl. 374/32; 356/222

(57) ABSTRACT

An optical power meter using a thermal detector, with improved response time, in which a fast response sensor is mounted close to the thermal detector, in such a location that it senses a part of the incident beam to be measured. The output signal of the fast response sensor, and the output signal of the thermal detector are electronically combined, such that response characteristics of the fast response sensor are impressed on the output of the thermal detector, thus providing a power meter combining the power handling ability and the accuracy of the thermal detector with a response characteristic of the fast response sensor. This method of combining fast and slow response sensors is also applicable to other measurements, whether physical, chemical or biological, such as those of flow, velocity, temperature, pressure, electrical, electronic, magnetic, thermal, optical, radiative, dimensional or acoustic properties of a material or article.

### FIELD OF THE INVENTION

The present invention relates to the field of thermal detector optical power meters and instrumentation for the measurement of other physical parameters, and especially to methods of speeding up their response time.

### BACKGROUND OF THE INVENTION

There exist in the art, several different types of power meter sensors, capable of measuring the power of a high power laser beams or high power optical beams from other sources. The term “high power” is a comparative term, which has widely variable meanings depending on the particular application to which the beam is being put. In this specification, being concerned with the field of power meters, the term “high power” is used and claimed to describe a source wherein the effect of the beam impingement on the power meter sensor produces noticeable heating of the sensor. Under these circumstances, the sensor needs generally to be constructed such as to withstand the local thermal effects of the impingement of the beam, by transfer of the heat away from the point of impingement of the sensor. In addition, the meter needs to be constructed such as to avoid damage to the whole of the sensor element, by ensuring transfer of the heat right out of the sensor, in order to prevent its overall temperature from rising. Since such sensors detect the thermal heating effects of the beam, they are generally known as thermal detectors. This distinguishes them from the type of detectors where the power is detected directly by conversion of the incident beam into a signal by means of a photoelectric effect, such as the photovoltaic or photoconductive effect, or by means of some other effect. In this specification, such detectors are given the generic name “direct conversion detectors”.

A commonly used method of transferring heat away from the impingement area is by means of heat conduction. The sensor element then detects this thermal flow of energy from the impingement area to the outside ambient environment, and a measure of this flow is used to define the power of the incident beam. One example of such a sensor, widely used today, is described in U.S. Pat. No. 3,596,514 to W. S. Mefferd et al, where the energy flow is determined from the temperature gradient generated in its path. In such sensors, the thickness, diameter and material of the impingement area is constructed such as to ensure that the impingement area is not damaged by excessive heating. The thickness, length and material of the heat conduction path are selected to ensure an adequate thermal flow rate so that neither the impingement area nor the thermocouple sensor element are excessively heated. On the other hand, the conduction path must retain a certain minimum level of thermal resistance in order generate a sufficient temperature gradient to be able to measure accurately.

Such a thermal flow path inevitably results in a comparatively slow response time, both because of the commensurate high thermal capacity of the impingement area of the flow path and because of the level of thermal resistance required to detect the flow. Furthermore, to avoid the chance of damage to the sensitive thermocouple element, it is generally located away from the area of impingement of the incident beam, such that there is a dead time during which the heat flows from the area of the impingement of the beam to the area of the thermocouple sensor. In the above mentioned patent, partial compensation for this slow response time is obtained by means of a circuit which proportionally adds the differential of the signal to the signal output itself. Such a circuit is able to decrease by a factor of approximately two to three, the effective response time of the sensor. The effective response time, for the purposes of this application, is defined as the time taken to get to 95% of the final reading without subsequent overshooting or undershooting of more than ±2% of the final reading.

In subsequently developed power sensors, more complex response time compensation functions are used, which are able to decrease the effective response time by almost a factor of 10. However, in, for instance, a meter designed for multi-kilowatt level lasers, the corrected response time of such power meters may still reach a number of seconds, and such response times are too long to allow rapid response to changes in the laser output power. Even for lower power levels, where suitable thermal power meters may have response times of hundreds of milliseconds, such response times are often too long to use, for instance, as the detector element for a fast response laser power control circuit.

Direct conversion detectors of the type mentioned above, on the other hand, have very fast response times. Similarly, there exist other detectors such as photoacoustic and pyroelectric detectors, and miniature bolometers and thermopiles, which are not strictly direct conversion detectors, but do respond much more quickly than the commonly used thermal detectors described above. However, none of these types of detectors are able to withstand the heating effects of high power lasers, and cannot therefore be used for such applications. Furthermore, some of these fast detectors are prone to drift with change in temperature, either because of inherent temperature sensitivity, such as the photoelectric types, or because their comparatively low thermal capacity makes them more susceptible to incident radiation. Furthermore, because of their small size, and because the beams measured are not generally of uniform profile, they are susceptible to changes in incident beam shape or position.

It would therefore be of considerable advantage if a thermal power meter sensor were available, which would be able to withstand the power levels of high power beams, yet would have an improved response time, closer to that of direct conversion detectors, or other high speed miniature detectors. Furthermore, it would also be advantageous if such a thermal power meter sensor also had the thermal stability of conventional thermal power meters.

The disclosures of all publications mentioned in this section and in all other sections of the specification, are hereby incorporated by reference, each in its entirety.

### SUMMARY OF THE INVENTION

The present invention seeks to provide, according to a preferred embodiment of the present invention, a new optical power meter, with improved response time compared to that obtained in prior art thermal detectors. The new optical power meter is preferably constructed by mounting a separate sensor, having a response time significantly faster than that of the thermal detector, close to the thermal detector of the power meter, in such a location that it senses a part of the incident beam to be measured, and responds thereto according to its characteristic response time.

A preferred way of sensing the incident beam is to mount the fast sensor such that it views radiation reflected or scattered from the impingement of the beam on the surface of the thermal detector. In order to provide for more uniformity, a plurality of fast sensors is preferably used, disposed around the thermal detector entrance aperture so that the radiation scattered in a plurality of directions is integrated and sensed. An alternative and preferable method involves the use of a beam splitter located such that it deflects part of the incident beam before impingement on the thermal disc, into the fast response sensor or sensors. A further preferred method is to use a thermal detector which transmits a part of the incident beam, and to allow the transmitted part of the beam to be sensed by the fast response sensor or sensors.

In accordance with a preferred embodiment of the present invention, the output signal of the fast response sensor or sensors, and the output signal of the thermal detector are input to an electronic circuit which is operative to combine the signal information from both detector types. By this means, the characteristics of the risetime of the fast response sensor or sensors is combined with the power handling ability and the accuracy and stability of the thermal detector. The result is a thermal detector, able to withstand the high incident powers characteristic of its usual range of use, and with a highly improved response time, characteristic of the fast response sensor.

There is thus provided in accordance with another preferred embodiment of the present invention, an optical power meter which can withstand the high power levels characteristic of a thermal detector, since the thermal detector acts as the main beam absorber, but which has a response time typical of a fast response sensor, since the signal from the fast response sensor or sensors is used for displaying the instantaneous power reading. In accordance with another preferred embodiment of the present invention, the optical power meter also has the accuracy associated with such a thermal detector, since it is the thermal detector which defines the ultimate power level measured. In accordance with yet another preferred embodiment of the present invention, the stability and absolute calibration capabilities of the thermal detector are maintained.

In accordance with different preferred embodiments of the present invention, the thermal detector may be a thermocouple detector of the type described in U.S. Pat. No. 3,596,514, or a pyroelectric detector, or any other similarly suitable thermal detector capable of handling the required power level, and the fast response sensor may be one of the direct conversion detectors of the types mentioned above, or a pyroelectric detector, or a single thermocouple junction, or a miniature thermopile, or a thermistor, or a bolometer, or a photoacoustic detector, or any other suitable sensor. A requirement of the fast response sensor is that it be of a type which responds to the wavelengths of the beams to be measured.

According to another preferred embodiment of the present invention, the electronic circuit is operative to correct the power reading obtained by the fast response sensors in accordance with the readings obtained from the thermal detector.

The particular aspect of the invention disclosed hereinabove, and in the detailed description of preferred embodiments, below, is applied to solving the problem of providing a fast response time to an optical power meter incorporating a thermal detector. Such a thermal detector generally has an inherently slow response time, related to its ability to absorb high powers, but it also has a number of advantages, such as its stability, robustness and accuracy.

It will, however, be appreciated by persons skilled in the art, that there exists a more universal problem in the provision of fast measurements, in a situation when the fast response time sensors available for the task in hand are less accurate, less stable or less robust than other types of available sensors, which are slower in response. This problem exists in many fields of measurement technology besides that of optical power meters. In many such fields, the more accurate, stable or robust types of measurement sensor may be slower in response by virtue of their operational principle, which may, for instance, require more actions or longer contact with the measured material or phenomenon or quantity than the simpler, faster sensors.

It should therefore be understood that the preferred aspects of the present invention, whereby the calibration of a fast but less accurate sensor is constantly corrected by means of a slower but more accurate, or more stable or more robust sensor, is not limited to the field of optical power measurement, but is applicable to other areas of measurement. Such areas of measurement may include the general determination of many physical quantities, where the term physical is used and claimed in this specification to also include chemical and biological quantities, since many of the measurements of these quantities may depend ultimately on physical phenomena. Furthermore, the measurement of such physical quantities may also be understood to include the measurement of characteristics or functionalities of materials, or the measurement of the properties of objects or of the environment, or the measurement of the dimensions of objects, or the measurement of distances, such as heights, or the measurement of the physical results of processes or phenomena occurring, Such physical quantities are broadly understood to include, but are not meant to be limited to such properties as flow, velocity, temperature, pressure, electrical, electronic, magnetic, thermal, optical, radiative, acoustic, or dimensional properties of materials or objects or processes; or chemical activity, concentration, solubility or pH value; or biological activities or levels or analyses which can be measured directly. Furthermore, such measurements may preferably be associated with, or originate from a solid, a liquid or a gaseous material, object or environment.

In accordance with yet another preferred embodiment of the present invention, there is thus also provided an instrument for measuring a physical quantity, consisting of a first sensor providing a first measurement of the physical quantity and having a first response time for the measurement, a second sensor for providing a second measurement of the physical quantity and having a second response time slower than that of the first sensor, and an electronic circuit for correcting the first measurement according to the second measurement.

In accordance with yet more preferred embodiments of the present invention, the first sensor may be less accurate, or less stable or less robust than the second sensor.

In accordance with still another preferred embodiment of the present invention, the physical quantity may be either a physical, a chemical or a biological quantity of a material. It may preferably be a flow, a velocity, a temperature, a pressure, an electrical, an electronic, a magnetic, a thermal, an optical, a radiative, an acoustic or a dimensional property of the material or object or process. Furthermore, the material or object may be a gas, a liquid or a solid.

There is further provided in accordance with still another preferred embodiment of the present invention, a method for measuring a physical quantity, consisting of the steps of providing a first sensor for making a first measurement of the physical quantity, having a first response time for the measurement, providing a second sensor for making a second measurement of the physical quantity, having a response time slower than that of the first sensor, and correcting the first measurement according to the second measurement by means of an electronic circuit.

In accordance with a further preferred embodiment of the present invention, there is also provided a power meter for measuring the power of optical radiation consisting of a thermal detector on which the optical radiation impinges, providing a signal having a response time to the optical radiation, a sensor having a response time faster than that of the thermal detector, which provides a measurement of the power by sensing a part of the optical radiation, and an electronic circuit for correcting the measurement according to the signal provided by the thermal detector.

In accordance with yet further preferred embodiments of the present invention, the power meter described above may have a response time characteristic of the sensor, or a power handling capacity characteristic of the thermal detector, or an accuracy characteristic of the thermal detector, or a combination of any of them.

Furthermore, in accordance with other preferred embodiments of the present invention, the part of the optical radiation may be reflected or scattered from the thermal detector of the power meter, or may be transmitted through the thermal detector of the power meter.

Furthermore, in accordance with yet another preferred embodiment of the present invention, there is provided a power meter as described above, and also consisting of a beam splitter for providing the part of the optical radiation, before impingement of the optical radiation on the thermal detector.

There is further provided in accordance with yet another preferred embodiment of the present invention, a power meter for measuring the power of optical radiation consisting of a thermal detector responsive to the optical radiation, having a first response time, and generating a first signal, at least one second detector, having a second response time significantly shorter than the first response time, mounted in proximity to the thermal detector such that the at least one second detector is also responsive to the optical radiation and generates a second signal, and an electronic circuit for combining the first and the second signals, and providing an output corresponding to the power, wherein the output has a response time having characteristics of the second sensor. Furthermore, the at least one second detector may be mounted such that it senses part of the optical radiation reflected or scattered from the front surface of the thermal detector.

There is also provided in accordance with a further preferred embodiment of the present invention, a power meter as described above, and wherein the thermal detector may be either a thermopile detector or a pyroelectric detector.

In accordance with yet more preferred embodiments of the present invention, the sensor of the power meter may be a photoelectric cell, a photodiode, a photoconductive element, a bolometer, a miniature thermopile, a photacoustic sensor, or a pyroelectric sensor

There is further provided in accordance with still another preferred embodiment of the present invention, an optical power meter electronic circuit for use in combining signals obtained from a thermal detector and from at least one fast response sensor, which corrects the signal obtained from the at least one fast response sensor according to the signal obtained from the thermal detector.

In accordance with a further preferred embodiment of the present invention, there is also provided an optical power meter electronic circuit as described above, and consisting of a first amplifier channel for the at least one fast response sensor, a second amplifier channel for the thermal detector, and a digitally controlled potentiometer for adjusting the output of the first amplifier chain according to the difference between the outputs of the first amplifier channel and the second amplifier channel.

There is provided in accordance with yet a further preferred embodiment of the present invention, a method of automatically adjusting the gain of a first electronic circuit, with respect to the known output of a second electronic circuit, consisting of the steps of making a first measurement of a parameter with the first circuit, making a second measurement of the parameter with the second circuit, subtracting the second measurement from the first measurement, reducing the gain of the first circuit, if the result of the subtracting is positive, and increasing the gain of the first circuit, if the result of the subtracting is negative. Additionally, the method described above may also consist of the step of temporally converting the response of the first circuit to that of the second circuit.

### BRIEF DESCRIPTION OF THE DRAWINGS

The present invention will be understood and appreciated more fully from the following detailed description, taken in conjunction with the drawings in which:

FIG. 1 depicts graphs showing the response to a step function input laser beam of a typical prior art photoelectric detector, and of a typical prior art thermal detector;

FIG. 2 is a schematic illustration of an improved thermal power meter head with a fast response time, constructed and operative according to a preferred embodiment of the present invention with fast response sensors and a thermal detector;

FIG. 3 is a schematic block diagram according to a preferred embodiment of the present invention, illustrating how the control electronic system combines the measured signals from the fast response sensors and from the thermal detector;

FIG. 4 is a preferred embodiment of a circuit diagram of the main amplifying circuits and the control circuit depicted schematically in FIG. 3;

FIG. 5 is a schematic flow chart according to a preferred embodiment of the present invention, showing the logic steps of the program by which the microcontroller shown in FIG. 4 computes the need to adjust the calibration of the Fast response channel, so that its signal complies with the level of the thermal detector signal; and

FIGS. 6A-6C are schematic illustrations of other preferred embodiments of the present invention, showing alternative arrangements and locations for the fast sensors from those shown in FIG. 2. FIG. 6A shows an embodiment using a beam splitter in the incident beam; FIG. 6B shows a thermopile disc with a number of holes in the absorber area; and FIG. 6C shows a partially transparent pyroelectric detector as the thermal detector.

### DETAILED DESCRIPTION OF PREFERRED EMBODIMENTS

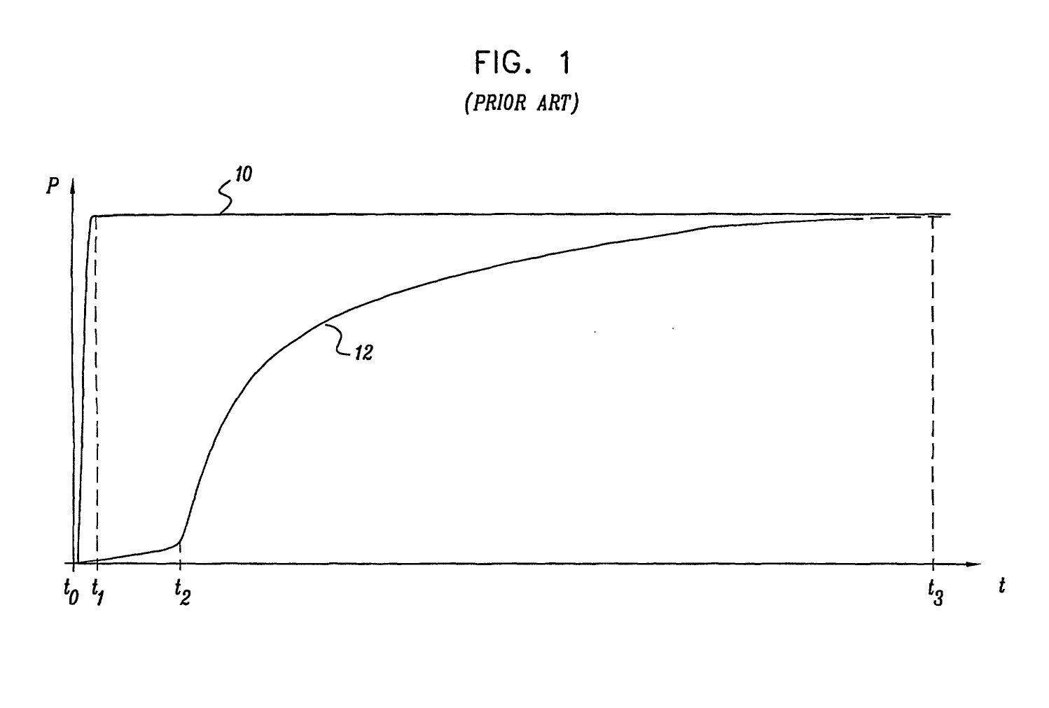

Reference is now made to FIG. 1, which depict graphs showing the response to a step function input laser beam of a typical prior art photoelectric detector, and of a typical prior art thermal detector, such as that described in U.S. Pat. No. 3,596,514. The laser beam is allowed to impinge on the detectors at point to on the time scale. The power detected is shown in curve 10 for the photodiode, and in curve 12 for the thermal detector. The risetime of the photodiode is rapid, reaching its final value after a time t₁, which could typically be of the order of microseconds or less for commonly used silicon photodiodes. The signal from the thermal detector at first does not show any noticeable rise, this corresponding to the time taken for the heat impinging on the center of the detector to diffuse out to the region of the thermocouple detection element. This process takes until time t₂. Thereafter, the risetime of the signal is approximately exponential, or a composite exponent, typical of two dimensional radial heat flow, reaching its effectively final asymptotic value after a time t₃. The risetime of the thermal detector is typically several orders of magnitude slower than that of the photoelectric sensor, and typically ranges from several hundred milliseconds for a thermal detector capable of handling 10 Watts of laser power, to the order of ten seconds for a multi-kilowatt thermal detector disc.

Though curve 10 is shown for a photodiode, a similar response time is expected for other types of direct conversion detectors. For the other types of fast sensors mentioned hereinabove, such as the bolometers, miniature thermopiles and photoacoustic detectors, the response is not as fast as the that of the photodiode, since they are not direct conversion detectors, but their response times are still many times faster than that of the thermal detector response shown.

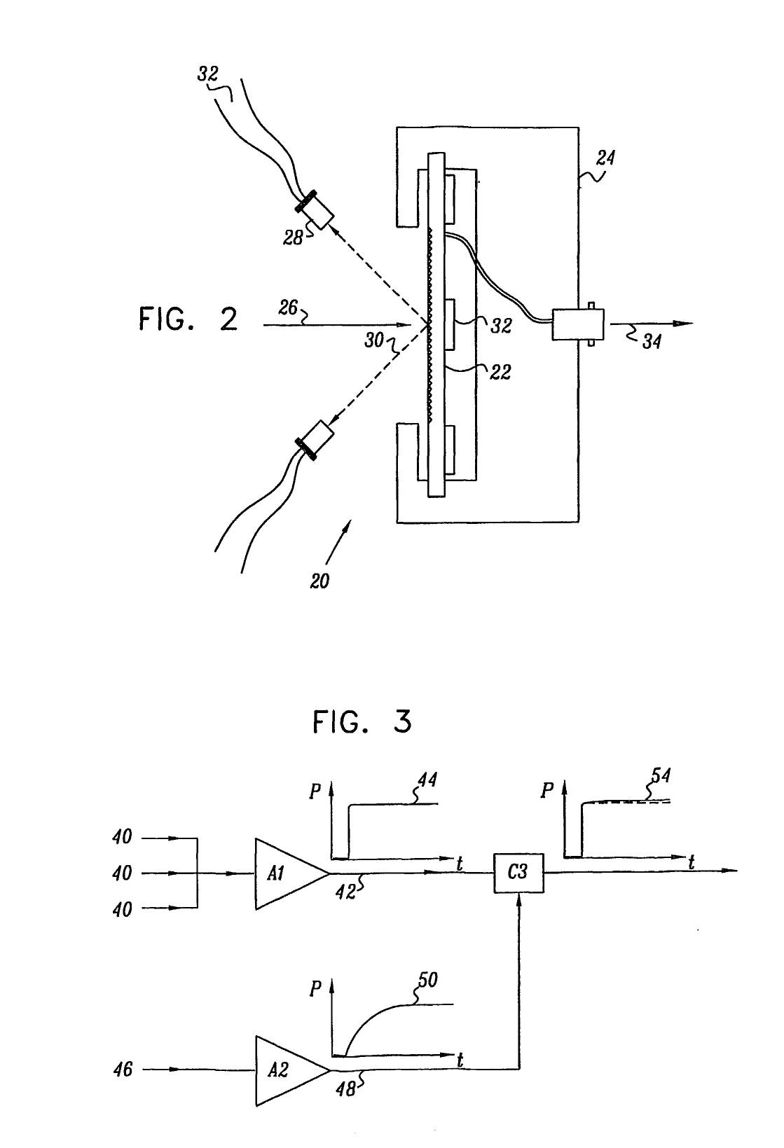

Reference is now made to FIG. 2, which is a schematic illustration of an improved thermal power meter head with a fast response time, constructed and operative according to a preferred embodiment of the present invention. The power meter head 20 preferably consists of a thermal detector disc 22, mounted in a heat dissipating head 24. The laser beam 26 impinges on the front surface of the thermal detector disc 22, and is essentially absorbed therein. Since however, the front surface of the disc is not a perfect absorber, a small part of the impinging laser beam is diffusely reflected or scattered back from the disc surface. Disposed around the periphery of the thermal detector disc, and at a small distance from its front surface, are a number of fast response sensors 28, sensitive at the wavelength of the laser beam being measured by the thermal detector. The entrance apertures of these fast response sensors are directed at the surface of the thermal detector disc, such that they measure laser radiation scattered from the surface of the disc. In order to avoid their saturation by the high level of scattered laser radiation detected, the sensitivity of the fast response sensors must be kept below a predetermined level. This can conveniently be achieved by means of neutral density filters placed in front of their entrance apertures. These filters also have the added side benefit of avoiding the effects of ambient lighting from disturbing the measurement of the scattered laser radiation. The number of fast response sensors is selected such that the radiation scattered in a plurality of directions is integrated and sensed, thus avoiding problems of dependence on beam profile or impingement position. Three or four are typically sufficient for this purpose.

According to different preferred embodiments of the present invention, the thermal detector disc may have a thermopile sensor element, or it may be a pyroelectric detector, or any other suitable detector which can withstand the incident power of the laser beam being measured. According to yet further different preferred embodiments of the present invention, the fast response sensors may be photodiodes, or photoconductive cells, or miniature thermocouple, bolometer, thermistor, pyroelectric or photoacoustic detectors, or any other suitable detectors with a response time significantly faster than that of the thermal detector, and sensitive to the wavelengths to be measured with the power meter. The output signals 32 from the fast response sensors, and the output signal 34 from the thermal detector are input to a control unit for processing and measuring.

Reference is now made to FIG. 3, which is a schematic block diagram according to a preferred embodiment of the present invention, illustrating how the control electronic system combines the measured signals from the fast response sensors and from the thermal detector to provide an output signal which combines the response time of the fast response sensor with the stability of the thermal detector signal, in an instrument capable of withstanding the high power levels of the thermal detector. In the preferred embodiment shown, the signals 40 from three separate fast response sensors are input into an amplifier A1 for adding and bringing to the desired level for further processing. At the output 42 of amplifier A1, a time response plot of the power measured by the three fast response sensors is shown as curve 44, and resembles the step function of the laser input beam. The signal 46 from the thermal detector is input into the amplifier A2, where it is brought to the desired level for further processing. At the output 48 of amplifier A2, a time response plot of the power measured by the thermal detector is shown as curve 50, and resembles an exponentially rising function, with a risetime characteristic of that of the thermal detector. According to a further preferred embodiment of the present invention, the amplifier A2 can optionally be constructed with a response time acceleration circuit, such that the output signal is sped up in relation to the input signal received from the thermal detector, as described hereinabove.

The output 42 from the combined fast response sensors may be inaccurate in measuring the laser power for a number of reasons. Firstly, the fast response sensors do not view the laser beam directly, but rather the radiation scattered from the thermal detector surface. The level of radiation scattered can change depending on the condition of the absorbing surface of the thermal detector, which can change with use, aging and damage. In addition, the level of radiation scattered depends on the size, the profile and the position of the beam impinging on the absorbing surface. In a further preferred embodiment of a power meter, constructed according to the present invention, the use of three suitably positioned fast response sensors provide a signal showing less than 5% fluctuation as a function of beam size, profile and position. However, when this small error is combined with the other factors mentioned here, the total accuracy level becomes unacceptable for most power measurement applications.

Photodiodes, being of low cost, sensitive, simple. to use, and reasonably linear over a large power range, are very commonly used as fast response power sensors. However, photodiodes, being semiconductor devices, may be susceptible to changes in their environmental temperature, and they cannot thus be easily used in absolute power measurements. Furthermore, they do not intrinsically provide a calibrated output signal, but must be calibrated against another detector, and as they are prone to aging or damage resulting from excessive overexposure, recalibration may need to be performed periodically. For all of the above reasons, although the output 42 from the combined fast response sensors may provide a temporally faithful measure of the laser beam, with a fast response time, it cannot be relied upon to provide an accurate power level measurement.

In order to correct inaccuracy in the power level measured by the fast response sensor channel, according to a preferred embodiment of the present invention, the signal is input to a control circuit C3, together with the output 48 of the thermal detector channel. The circuit C3 is operative to compare the power level measured by the fast response channel with that obtained by the thermal detector channel, and to adjust the fast response channel reading so that the reading obtained is the same as that of the thermal detector channel. This adjustment process is performed on a continuous and iterative basis. The output signal 52 from circuit C3 is then a good temporal representation of the changes in power of the beam being measured, typical of the response time of the fast response sensors, but with the accuracy and calibration stability typical of a thermal detector impressed upon it.

For the situation existing the first time that the instrument is switched on, a time response plot of the power output measurement 52 of a step function input beam is shown in curves 54. It is observed that the measured power, shown by the solid line in graph 54, shows the characteristic fast response time of the fast response sensors, as seen in graph 44, but after reaching the level at the end of the step function, the signal from the thermal detector is added as a small correction, as shown by the dotted line in graph 54, which adjusts the final reading iteratively to an accurate value, within a time commensurate with the response time of the thermal detector, as shown in graph 50.

Once this initial process of calibration of the fast response sensors by means of the thermal detector has been performed for the first time, the fast response sensor calibration is stored by the control circuit in a non-volatile memory, and so long as no change occurs in this calibration, the fast response sensors provide an accurate reading of the incident beam power, traceable to the thermal detector accuracy, but with the response time of the fast response sensors. If the effective calibration of the fast sensor reading drifts, such as could be caused, for instance, by a gradual change in their temperature, or by a change in the beam position or size, circuit C3 is operative to continually track such a sensitivity change by continual and iterative comparisons with the reading obtained from the thermal detector. If, on the other hand, a sudden change in effective sensitivity occurred, such as could be caused by a sudden shift in beam position or shape, a time typical of the response time of the thermal detector would be required to bring the calibration of the fast sensors back into good agreement with the calibration of the thermal detector, as explained for the situation of initial use in graph 54. In all normal measurement situations, though, no such delay is experienced, and calibration corrections are effectively transparent.

The fast response sensor calibration is periodically stored to a non-volatile memory. Therefore, any time that the instrument is subsequently switched on, the fast response is restored to the calibration which was last stored to the nonvolatile memory, which is representative of the adjusted calibration during the last prior period of operation. However, the very first time that the instrument is used, no prior calibration had been stored to the non-volatile memory, and the calibration of the fast response sensor is arbitrary and presumably not accurate. For this reason, the first use of the instrument is unique in that proper calibration of the fast response sensor is not immediate but only obtained after a certain amount of operating time, as explained above.

According to the preferred embodiment of the present invention as described hereinabove, there is thus provided a laser power meter which can withstand the high power levels characteristic of a thermal detector since the thermal detector acts as the main beam absorber, and with the accuracy associated with such a thermal detector, since the thermal detector defines the ultimate power level measured, but with a response time typical of a fast response sensor, since it is the signal from the fast response sensor or sensors which provides the power reading. Only sudden changes in measurement conditions should cause this reading to deviate from an accurate power reading, and even then, the reading rapidly converges thereunto.

According to further preferred embodiments of the present invention, if the fast sensor is a silicon photodiode, the laser power meter may be used in the near UV, visible, and near IR regions of the spectrum, depending on the exact type of photodiode used. If the fast response sensor is a pyroelectric sensor, or a miniature bolometer, or a thermistor, or a miniature thermocouple, or another suitable sensor, the power meter can be used over a much wider range, even into the far IR, depending on the spectral properties of the absorbing coating used on the sensor. For example, according to another preferred embodiment of the present invention, miniature thermocouple detectors available from the Dexter Research Center of Dexter, Mich., and having a response time of 18 msec., may be used as the fast response sensors. In this case, the fast response, high power laser power meter can be used with CO₂ lasers at 10.6 μm. It is to be understood to one skilled in the art, that if an AC coupled detector, such as a pyroelectric element, is used as the fast response sensor, suitable chopping means and amplifying circuitry can be used to enable the sensor to measure the essentially DC power of the laser beam.

The circuit shown in FIG. 3 is also applicable for use with instruments operative in other areas of measurement, besides optical power measurement, such as those mentioned in the summary section of this application. According to the preferred embodiments for use with these other applications, the input or inputs 40 are used for the fast response sensor or sensors, and the input 46, for the slower response, more accurate or stable sensor. The form of response shown in the curves 44, 50 and 54 may be somewhat different in different applications, but the operating method is similar, in that the circuit C3 is operative to compare the physical quantity measured by the fast response channel with that obtained by the slow response channel, on a continuous and iterative basis, and to adjust the fast response channel reading so that the reading obtained is the same as that of the slow response channel.

As previously stated, this measurement method and apparatus are applicable to the measurement of many physical quantities, including but not limited to the measurement of flow, temperature, pressure, chemical properties, or other such properties or parameters of materials, whether solids, liquids or gases. Some possible examples of applications are now given to illustrate some types of measurement systems in which the present invention may be advantageously used.

When measuring the temperature in the air space of a room or other volume, such as for controlling the level of cooling applied by an air conditioning system, thermostatic controls are used, typically based on bimetallic elements. These provide accurate temperature control, but are comparatively slow and thus have a time lag. If there is need to control the temperature and to respond rapidly to fluctuating thermal loads, such as is required in some industrial processes, an infra-red sensor can be used for surveilling the area of interest. Such an IR sensor can detect changes in temperature effectively instantaneously, but is difficult to calibrate accurately with respect to temperature. According to another preferred embodiment of the present invention, a temperature measurement system can be provided in which a bimetal or other accurate thermometer, which has a slow response time, is used to provide almost continuous calibration correction to a fast but inaccurate temperature sensor, such as an IR detector element, such that a fast and accurate measurement system is obtained.

There are several simple and fast methods of measuring the mass flow of a fluid through a pipe. One such method involves the measurement of the pressure drop through a known orifice. This pressure measurement can have a very fast response, but the measurement is not very accurate and depends on the ambient temperature, the fluid viscosity, and other possible factors. An alternative method of flow measurement, which also uses a pressure measurement, and is hence fast but not particularly accurate, is by use of a Pitot tube. A much more accurate, but slow method of measuring mass flow is by means of a heated tube. A specific quantity of heat is applied to the fluid as it goes through the tube, and the temperature difference is measured upstream and downstream of the heat source. If the specific heat of the fluid is known, this being a quantity which varies more slowly with temperature, than for instance viscosity, it is simple to calculate the mass flow to a high level of accuracy, but this measurement can only be performed slowly. As in the previous example, the methods of the present invention can be used to enable the accurate but slow sensor to provide continuous recalibration of the fast sensor, such that a fast response but accurate mass flow meter can be provided.

The measurement of the pH or ion concentration of a solution using an accurate electrode, is a slow process with a response time of several seconds. Measurement of conductivity, however is very fast, and can be approximately correlated to either pH or ion concentration, but does not enable an accurate measurement to be performed. As previously, according to another preferred embodiment of the present invention, a fast and accurate measurement of pH or ion concentration can be accomplished by calibrating the fast conductivity measurement by means of the more accurate but slow pH electrode.

Another example for the application of the methods and apparatus of the present invention, is to be found in the measurement of the height of aircraft. Though the use of GPS height sensing is now becoming prevalent, there are two other height sensors in common use, a barometric altimeter and an inertial sensor. The barometric sensor responds comparatively slowly, but is very accurate. The inertial sensor, which uses the second integral of the vertical acceleration output of a inertial guidance system, responds very quickly, but is not very accurate, as it acquires accumulated errors during flight, and requires regular recalibration. Though the inertial altimeter is used during high-g aircraft maneuvers, it cannot be used as an absolute height sensor, but is always referenced to the barometric sensor before every use, to provide it with a correct initial height measurement. According to yet another preferred embodiment of the present invention, there could be provided an altimetric system which uses the inertial height measurement data, continually corrected by the barometric altimeter using the methods of the present invention, such that a fast responding and accurate altimeter could be provided.

It is to be understood that the above mentioned applications are but examples of preferred applications of the methods and apparatus of the present invention, and are not meant to limit the invention to the specific embodiments described.

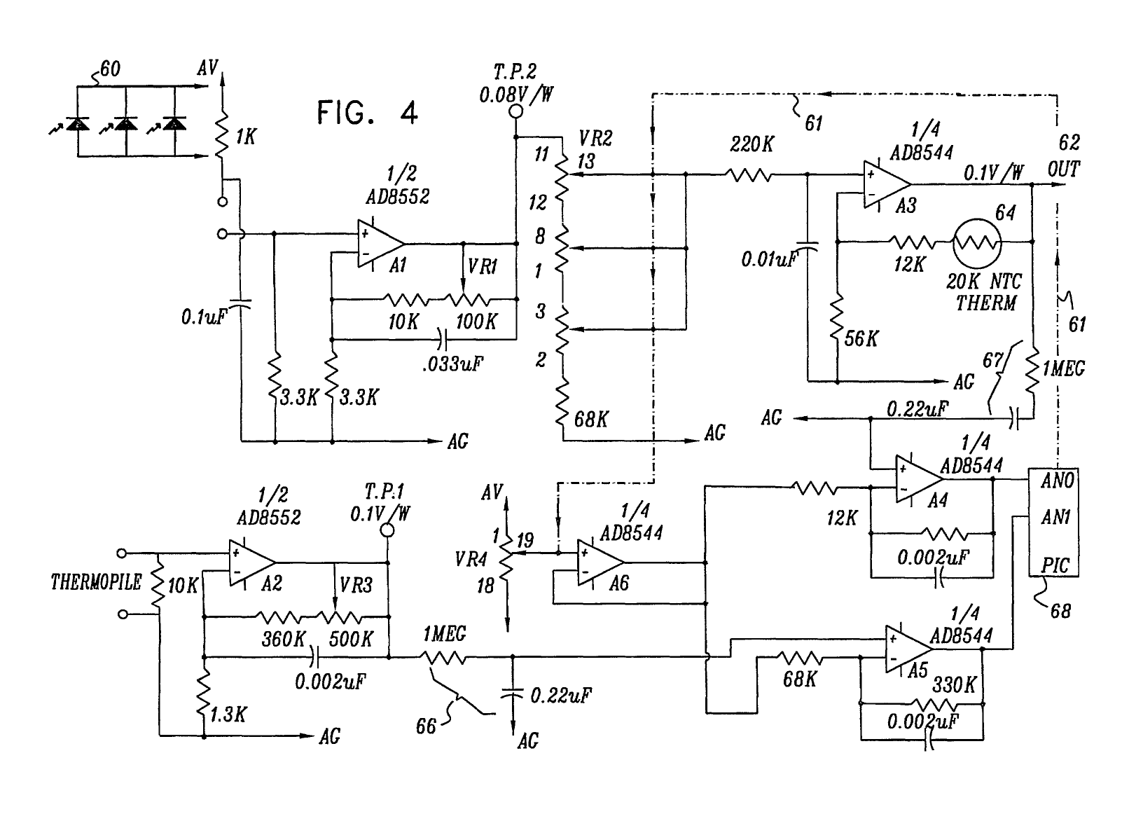

Reference is now made to FIG. 4, which is a preferred embodiment of a circuit diagram of the main amplifying circuits A1 and A2 and the control circuit C3 depicted schematically in FIG. 3. In the preferred embodiment shown in FIG. 4, the circuit is described for use with an optical power meter, though it is to be understood that the circuit could also be applied for use, according to the present invention, with other measurement instruments incorporating a fast response sensor of limited accuracy or stability, with a slower sensor of higher accuracy or stability, as described hereinabove. In FIG. 4, the fast response sensors used are photodiodes 60, whose outputs are connected in parallel. At maximum illumination, the photocurrent develops about 0.1 volt across the 3.3 kΩ input resistor. A 5 volt analog voltage bias AV, ensures that the photodiodes are always forward biased, such that they operate in their linear region of response. Furthermore, they act as current sources and their outputs can thus be legitimately added in parallel to give a signal proportional to the total integrated radiation detected by all three of them.

The signal is preferably input to preamplifier A1, at whose output a test point TP1 is provided. Correct preamplifier gain of the fast response channel is ensured by adjusting the amplification of A1 by means of VR1 to obtain the correct predetermined output signal on TP1 for a known laser input power. This adjustment procedure is performed initially after manufacture, and may be repeated periodically to compensate for any significant changes in the fast sensor sensitivity due, for instance, to serious aging or damage of the absorber surface, which may stretch the calibration correction ability beyond its available range.

The output signal is then preferably divided down by means of the variable potentiometer VR2, which is preferably a nonvolatile digital potentiometer, such as the Model X9241 manufactured by Xicor Inc., of Milpitas, Calif. The resistance value selected is stored in a non-volatile memory, such that the instrument maintains its calibration even after switch-off. This particular model is built on a monolithic CMOS microcircuit, and has four resistor arrays, each with 64 taps. Three of these arrays are used in series in VR2, and are ganged such that effectively 190 resistor taps are available for improved resolution. The position of the potentiometer “wiper” is determined by the control signal 61 from the microcontroller, as will be explained hereinbelow. The allowed control signals are limited such that VR2 preferably provides about ±20% variation in the output signal of A1 from the center of the adjustment range.

The selected fraction of the output signal from A1 is preferably further amplified by A3, which has an input filter with a time constant of 2.2 msec, to limit the dynamic response of the channel. The output signal 62 is passed to an indicating device for displaying or for recording the power measured. The feedback loop of amplifier A3 preferably includes a thermistor 64, which is mounted in the power meter head, and whose characteristics are selected such that the change in sensitivity of the photodiodes with temperature is approximately compensated by means of the change in amplification of A3 resulting from the change in the resistance of the thermistor 64, as is well known in the art. At its output, amplifier A3 has a filter 67 with a 0.22 sec. time constant, in order to limit the dynamic response of the fast response channel to suit the repetition rate of the control loop, preferably set at 5 Hz, as will be explained hereinbelow.

The output signal is also preferably applied to the positive input of operational amplifier A4, whose function will be explained below. A4 preferably has an amplification of five, and its output is input to one of the analog inputs of the microcontroller 68, which is preferably a model PIC12C671, manufactured by Microchip Technology Inc., of Chandler, Ariz.

The signal from the thermal detector is input to amplifier A2, at whose output a test point TP2 is provided. Correct calibration of the thermal channel, and hence the ultimate calibration adjustment of the complete instrument, is ensured by adjusting the amplification of A2 by means of VR3 to obtain the correct predetermined output signal on TP2 for a known input power. This known input power may preferably be obtained either from a laser source of known to power, or from a calibration heater thermally attached to the rear side of the disc, as illustrated by item 33 in FIG. 2, as is well-known in the art. At its output, preamplifier A2 has a filter 66 with a 0.22 sec. time constant, in order to limit the dynamic response of the thermal channel to suit the repetition rate of the control loop, preferably set at 5 Hz, as will be explained hereinbelow.

The thermal channel signal is applied to the positive input of operational amplifier A5, identical to A4, whose function too will be explained below. A5 preferably has an amplification of five, and its output is input to a second of the analog inputs of the microcontroller 68.

The overall operational function of the microcontroller, according to this preferred embodiment of the present invention, is to continually compare the power reading obtained from the thermal detector channel, which is known to give an accurate. measurement of the laser power, with that given by the fast response channel, which may give an inaccurate measurement of the laser power for any of the reasons stated hereinabove. If any discrepancy is detected between the two readings, the microcontroller provides a command signal 61 to the digital potentiometer VR2, such that the overall gain of the fast response channel is incrementally changed in order to bring the fast response measurement into agreement with the thermal channel measurement. In this way, the fast response measurement is constantly amended to provide an accurate reading of the laser power, as determined by the thermal detector, this amendment taking place at a rate determined by the repetition rate of the control loop. The filters 66 and 67 are operative in order to filter out any variations in either of the signal channels, substantially faster than the control loop rate.

The functions of amplifiers A4 and A5 are now explained. The PIC12C671 microcontroller 68 has an 8-bit A/D converter at its input, providing a resolution of 1/256. Since the resolution required of the laser power measurement should be at least 0.1%, i.e. one part in a thousand, which requires 10-bit data, there is need to avoid accuracy truncation by the 8-bit A/D converter. In order to achieve this, the signal representing the power measurement is offset by a known voltage to keep approximately the least significant 20% thereof, and this part is amplified by a factor of about 5 before input to the A/D converter, to maintain the required resolution. The offset signal is obtained at the output of operational amplifier A6, which outputs a buffered voltage divided out of the 5 volt analog voltage supply AV by the setting of VR4. VR4 is the fourth resistor array of the digital potentiometer, and its setting is determined by the control signal 61 output by the microcontroller 68. A large signal, approaching a full scale measurement, requires almost the maximum offset, while a small signal, of less than 20% of full scale, does not require any offset, since it will be handled with its full accuracy by the 8-bit A/D converter of the microcontroller even after the five-times amplification. The microcontroller is operative to sense the signal level, and to adjust the value of VR4 accordingly. The output signal of A6 is subtracted from the fast response signal to provide its offset at the input to A4, and likewise for the thermal detector signal at the input to A5.

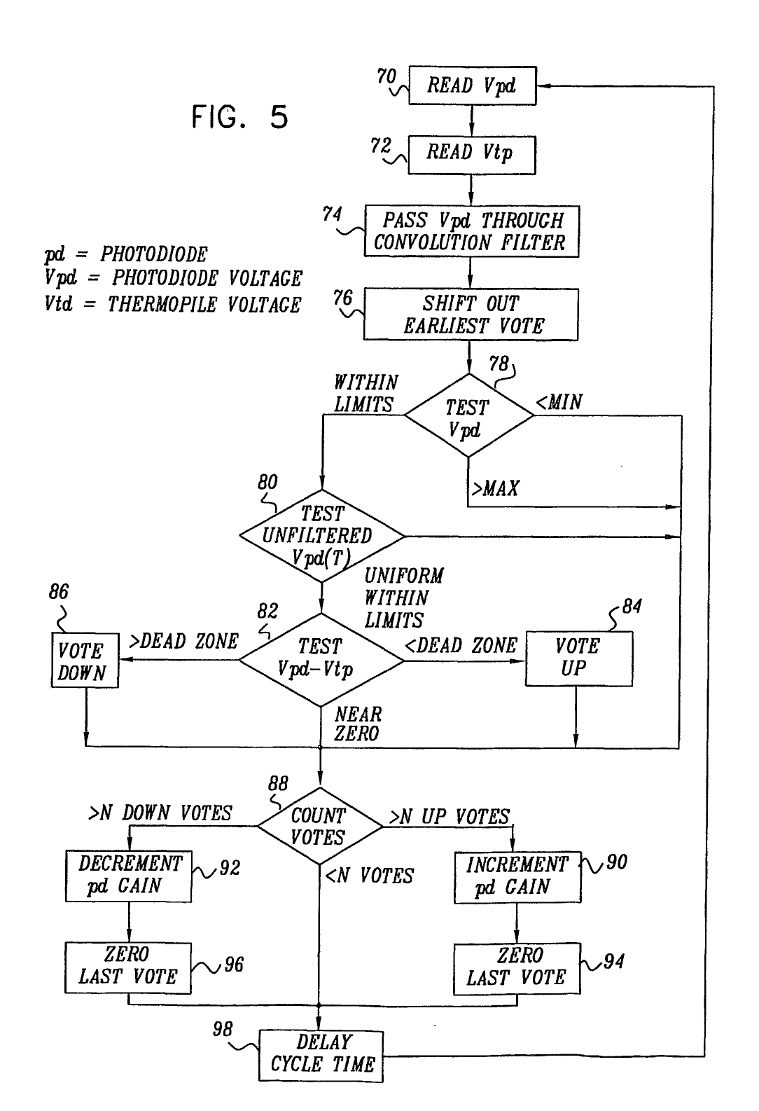

Reference is now made to FIG. 5, which is a schematic flow chart according to a preferred embodiment of the present invention, showing the logic steps of the program by which the microcontroller computes the need to adjust the calibration of the fast response channel, so that its signal complies with the level of the thermal detector signal. In the preferred embodiment shown, the fast response sensor is a photodiode, whose voltage output is marked Vpd, while the thermal detector is a thermopile detector, whose output is marked Vtp.

In step 70, Vpd is read, and in step 72, Vtp is read. The cycle time of the control loop is preferably 200 msec, such that each channel is read every 200 msec. A comparison must now be made on a continuous temporal basis between the levels of the two signals. However, because of the different time response of each signal to a change in the laser power, their temporal behavior is different. In order therefore, to make any comparison between them temporally meaningful, the signals have to be brought to the same effective point in time with respect to any change in the laser beam power being measured. The actual thermopile output voltage can mathematically be expressed by the convolution of a signal representing the instantaneous laser power with a time dependent function, representing the known time response function of the thermopile disc. In order to compare, at equivalent points in time, the effectively instantaneously responding photodiode signal with the slower responding thermopile signal, the photodiode signal should be convoluted with the same time dependent function as is applied physically by the thermopile disc to the laser input, such that the photodiode reading behaves temporally as though it had the same response as the thermopile disc. The two signals can then be equitably compared at any point in time. Vpd is thus passed through a digital convolution filter in step 74.

Decisions to increment or decrement the gain of the fast response channel are preferably made on the basis of votes collected over several loop cycles. This method of counting votes, rather than making the decision as per the result of each measurement cycle, has a smoothing effect on the decision making process. It ensures that the effects of random noise on the decision are largely eliminated, and the need to increment or decrement the gain is determined more definitely. This strategy of deciding when to adjust the gain of the instrument is all the more important since the measurements of the fast response sensor are likely to show a certain non-negligible level of noise that occurs naturally. This means that there will be plus and minus fluctuations between the two channels even if the calibration is maintained perfectly. If the vote strategy were not adopted, but gain adjustment were made every cycle, these natural noise fluctuations could cause constant hunting, with the ultimate effect of increased noise. These votes are preferably stored in memory analogous to a shift register. In step 76, the earliest vote is shifted out of the “shift register”, in order to make room for the vote of the current loop cycle.

A number of criteria are now applied to the values of Vdp and Vtp before any comparisons and calibration adjustments are made. Firstly, the power level measured must preferably be above a certain minimal level, typically around 10% of the full scale value, in order to ensure that the accuracy of the calibration compensation method is meaningful. In addition, the power level measured must preferably not be over a value close to but less than full scale, since any reading at full scale could arise from a laser power that is in fact higher than the full scale reading indicated, rendering the calibration meaningless. Investigation of these criteria is performed in step 78. If the reading does not pass these criteria, then a decision is taken not to cast a vote in favor of changing the gain for that measurement cycle.

A further criterion tested is whether the values of Vpd are reasonably consistent, indicating that no abrupt or drastic change has taken place in the laser power. Calibration is more reliably and more accurately performed if the input power is not undergoing a drastic change. For this reason, if the power is not constant within certain predetermined limits, a vote in favor of changing the gain is not cast, as indicated by the control path marked “NOT UNIFORM”. If successive stored values of the unfiltered Vpd are uniform within predefined limits, those values are used in the recalibration process. This decision is taken at step 80.

If the Vpd signal under scrutiny passes the previous criteria, it is preferably compared in step 82 with the current value of Vtp in memory. If the value of Vpd is less than the value of Vtc by more than a predefined percentage, indicative of a well defined divergence of the two values, then a vote to increase the gain of the fast response channel is entered, as shown in step 84. Similarly, if the value of Vpd is greater than the value of Vtc by more than a predefined percentage, indicative of a well defined divergence of the two values, than a vote to decrease the gain of the fast response channel is entered, as shown in step 86. This predefined percentage is known as the dead zone, and if both of the signals fall within this dead zone, no vote in favor of changing the gain is cast.

In step 88, votes from a number of successive cycles are preferably counted, and if there are more than a certain predefined number of votes to increase the gain in the fast response channel, this is done in step 90. Likewise, if there are more than a certain predefined number of votes to decrease the gain in the fast response channel, this is done in step 92. If at the vote count in each cycle, the number of votes is less than the certain predefined number, then no gain changing action is taken, and control passes via step 98 back to step 70, where a new measurement cycle is commenced.

The decision to change the gain in the fast response channel is preferably executed by means of one increment or decrement of gain, and the decision is taken as the accumulated outcome of a number of votes. In the preferred embodiment of the laser power meter, an accumulated number of 6 votes is used as the decision criterion, out of a total number of 8 loop cycles of measurements stored in the shift register 76. In this way, the effect of any large fluctuations due to spurious events or noise spikes are eliminated, and a steady and controlled change in calibration is achieved, making the whole calibration change process effectively transparent to the measurement being effected.

Once a gain increment or decrement has been performed, the vote which caused the increment or decrement is changed to zero in steps 94 and 96 respectively, so as not to influence successive vote counts. The program then waits at step 98 for the commencement of the next comparison cycle, every 200 msec. in the presently described embodiment, and control returns to step 70 where the next value of Vpd is read into the shift register.

Although the flow chart described above, illustrates the logic steps used in a program, according to a preferred embodiment of the present invention, by which a microcontroller computes the need to adjust the calibration of one channel of a laser power meter, so that its signal complies with the level of the signal from a second channel of that power meter, it will be appreciated by persons skilled in the art that this aspect of the present invention is equally applicable for solving the general problem of adjusting the gain of any electronic circuit with respect to the output of another electronic circuit to which the first is referenced. Such an embodiment of the present invention may then have applications in any electronic instrument where automatic calibration is performed of one channel according to the readings of a second channel.

Thus, according to another preferred embodiment of the present invention, a program similar to that described in the flow chart may be used in a method of automatically adjusting the gain of a first electronic circuit, with respect to the output of a second electronic circuit. The method consists of the steps of:

(a) making a first measurement of a parameter with the first circuit;

(b) making a second measurement of the parameter with the second circuit;

(c) subtracting the second measurement from the first measurement, and then

(d) either reducing the gain of the first circuit if the first measurement is greater than the second, or increasing the gain of the first circuit, if the first measurement is less than the second.

All of the above preferred embodiments have been described in terms of fast sensors located in such a position that they sense that part of the incident beam reflected or scattered from the front surface of the thermal detector. This is only one possible preferred location for the fast response sensors, and it is to be understood that the present invention may also be constructed with the fast response sensors in other preferred situations or positions that can quantitatively sense the beam to be measured.

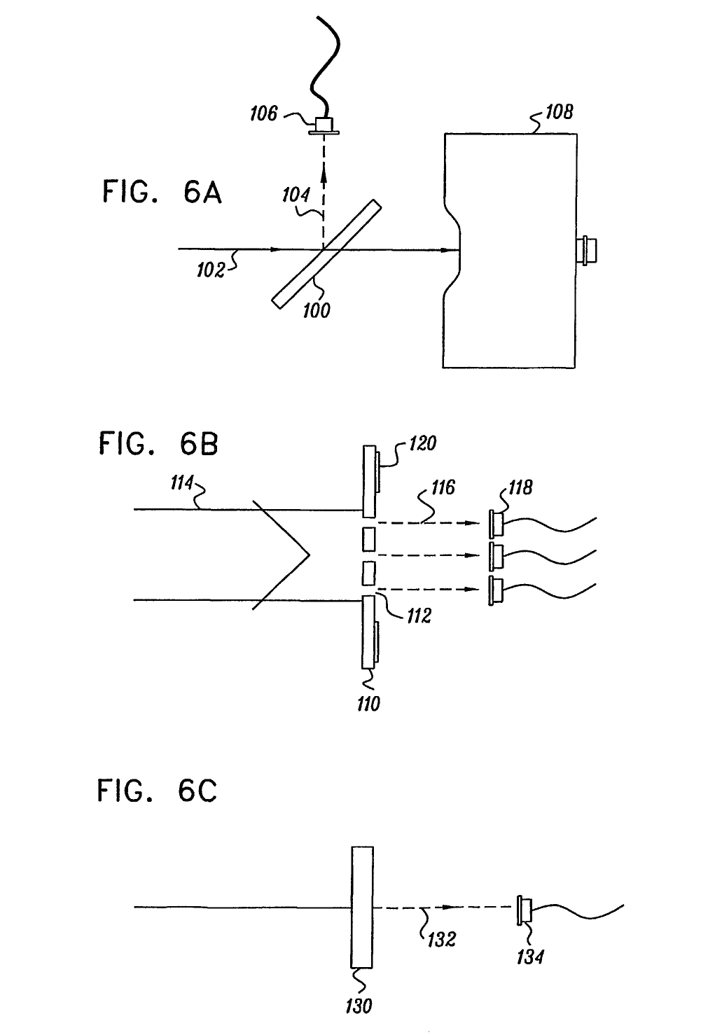

Reference is now made to FIGS. 6A to 6C which are schematic illustrations of other preferred embodiments of the present invention, showing the fast sensor or sensors in alternative arrangements and locations. FIG. 6A shows a preferred embodiment, in which a beam splitter 100 is inserted into the incident beam path 102, and a small fraction of the incident beam 104 diverted into the fast sensor or sensors 106. The main part of the beam is transmitted through the beam splitter 100 to the thermal detector 108. The power measured by the thermal detector must be compensated for that part of the power deflected out of the main beam and into the fast sensor or sensors. This correction is similar to the correction, well known in the art, made to the power measured at the absorber surface of the thermal detectors described in the embodiment shown in FIG. 2, for the percentage of incident power reflected or diffused from the surface, and not therefore measured.

Reference is now made to FIG. 6B, which shows another preferred embodiment wherein a thermopile detector disc 110 of the power meter has small holes 112 drilled in its absorber surface, such that part of the impinging beam 114 passes through the disc 116 and is sensed by a fast sensor or sensors 118 located behind the detector disc in the line of the incident beam. The main part of the beam is sensed in the usual manner by the thermopile array 120 on the thermal disc 110.

Reference is now made to FIG. 6C, which shows another preferred embodiment of the present invention, wherein the thermal detector is a pyroelectric detector disc 130, constructed of a material partially transparent to the optical radiation being measured, which allows a part 132 of the incident beam to be transmitted therethrough. The fast sensor or sensors 134 are then located behind the detector disc in the line of the incident beam.

It is appreciated by persons skilled in the art that the present invention is not limited by what has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

I claim:

1. An instrument for measuring a physical quantity, comprising:
a first sensor providing a first measurement of said physical quantity, and having a first response time for said measurement;
a second sensor, for providing a second measurement of said physical quantity, and having a second response time slower than that of said first sensor; and
an electronic circuit for correcting said first measurement according to said second measurement.

2. An instrument according to claim 1 and wherein said first sensor is less accurate than said second sensor

3. An instrument according to claim 1 and wherein said first sensor is less stable than said second sensor

4. An instrument according to claim 1 and wherein said first sensor is less robust than said second sensor

5. An instrument according to claim 1 and wherein said physical quantity is selected from a group consisting of a physical, chemical and biological quantity.

6. An instrument according to claim 1 and wherein said physical quantity is selected from a group consisting of a flow, a velocity, a temperature, a pressure, an electrical, an electronic, a magnetic, a thermal, an optical, a radiative, an acoustic and a dimensional property.

7. An instrument according to claim 1 and wherein said physical quantity is measured on a material.

8. An instrument according to claim 1 and wherein said physical quantity is measured on an object.

9. An instrument according to claim 1 and wherein said physical quantity is measured on an environment.

10. An instrument according to claim 1 and wherein said physical quantity is measured on a process.

11. An instrument according to claim 1, and wherein the subject of said measurements is selected from a group consisting of a gas, a liquid and a solid.

12. An instrument according to claim 1 and wherein said physical quantity is a distance.

13. An instrument according to claim 12 and wherein said distance is a height.

14. An instrument according to claim 12 and wherein said distance is a dimension of an object.

15. A method for measuring a physical quantity, comprising the steps of:
providing a first sensor for making a first measurement of said physical quantity, having a first response time for said measurement;
providing a second sensor, for making a second measurement of said physical quantity, having a response time significantly slower than that of said first sensor; and
correcting said first measurement according to said second measurement by means of an electronic circuit.

16. A method according to claim 15 and wherein said physical quantity is selected from a group consisting of a physical, chemical and biological quantity.

17. A method according to claim 15 and wherein said physical quantity is selected from a group consisting of a flow, a velocity, a temperature, a pressure, an electrical, an electronic, a magnetic, a thermal, an optical, a radiative, an acoustic and a dimensional property.

18. A method according to claim 15 and wherein said physical quantity is measured on a material.

19. A method according to claim 15 and wherein said physical quantity is measured on an object.

20. A method according to claim 15 and wherein said physical quantity is measured on an environment.

21. A method according to claim 15, and wherein the subject of said measurements is selected from a group consisting of a gas, a liquid and a solid.

22. A power meter for measuring the power of optical radiation comprising:
a thermal detector on which said optical radiation impinges, providing a signal having a response time to said optical radiation;
a sensor having a response time faster than that of said thermal detector, which provides a measurement of said power by sensing a part of said optical radiation; and
an electronic circuit for correcting said measurement according to the signal provided by said thermal detector.

23. A power meter according to claim 22 and which has a response time characteristic of said sensor.

24. A power meter according to claim 22 and which has a power handling capacity characteristic of said thermal detector.

25. A power meter according to claim 22 and which has an accuracy characteristic of said thermal detector.

26. A power meter according to any of claims 22 to 25 and wherein said part of said optical radiation is reflected from said thermal detector

27. A power meter according to any of claims 22 to 25 and wherein said part of said optical radiation is scattered from said thermal detector

28. A power meter according to any of claims 22 to 25 and wherein said part of said optical radiation is transmitted through said thermal detector

29. A power meter according to any of claims 22 to 25 and also comprising a beam splitter for providing said part of said optical radiation before impingement of said optical radiation on said thermal detector.

30. A power meter according to any of claims 22 to 29 and wherein said thermal detector is selected from a group consisting of a thermopile detector and a pyroelectric detector.

31. A power meter according to any of claims 22 to 30 and wherein said sensor is selected from a group consisting of a photoelectric cell, a photodiode, a photoconductive element, a bolometer, a miniature thermopile, a photacoustic sensor, and a pyroelectric sensor.

32. A power meter for measuring the power of optical radiation comprising:
a thermal detector responsive to said optical radiation, having a first response time, and generating a first signal;
at least one second detector, having a second response time significantly shorter than said first response time, mounted in proximity to said thermal detector such that said at least one second detector is also responsive to said optical radiation and generates a second signal; and
an electronic circuit for combining said first and said second signals and providing an output corresponding to said power, wherein said output has a response time having characteristics of said second sensor.

33. A power meter for measuring the power of optical radiation according to claim 32 and wherein said at least one second detector is mounted such that it senses part of said optical radiation reflected from the front surface of said thermal detector.

34. A power meter for measuring the power of optical radiation according to claim 32 and wherein said at least one second detector is mounted such that it senses part of said optical radiation scattered from the front surface of said thermal detector.

35. A power meter according to any of claims 32 to 34 and wherein said sensor is selected from a group consisting of a photoelectric cell, a photodiode, a photoconductive element, a bolometer, a miniature thermopile, a photacoustic sensor, and a pyroelectric sensor

36. An optical power meter electronic circuit for use in combining signals obtained from a thermal detector and from at least one fast response sensor, which corrects the signal obtained from said at least one fast response sensor according to the signal obtained from said thermal detector.

37. An optical power meter electronic circuit according to claim 36, and comprising:
a first amplifier channel for said at least one fast response sensor;
a second amplifier channel for said thermal detector; and
a digitally controlled potentiometer for adjusting the output of said first amplifier channel according to the difference between the outputs of said first amplifier channel and said second amplifier channel.

38. A method of automatically adjusting the gain of a first electronic circuit, with respect to the gain of a second electronic circuit, comprising the steps of:
making a first measurement of a parameter with said first circuit;
making a second measurement of said same parameter with said second circuit;
adjusting said gain of at least one of said first circuit and said second circuit according to the difference between said first measurement and said second measurement.

39. The method of claim 38, and also comprising the step of temporally converting the response of said first circuit to that of said second circuit.

40. The method of claim 38, and wherein said adjusting of said gain of at least one of said first circuit and said second circuit is performed to reduce a difference between said first measurement and said second measurement.
